(19) United States
(12) Patent Application Publication
(10) Pub. No.: US 2014/0096003 A1
(43) Pub. Date: Apr. 3, 2014

(54) Vehicle Audio System Interface

(71) Applicant: TESLA MOTORS, INC., Palo Alto, CA (US)

(72) Inventors: Miriam Vu, San Francisco, CA (US); Brennan Boblett, San Francisco, CA (US); Nalinichandra Penke, Fremont, CA (US); Kevin Hsieh, Redwood City, CA (US); Joe Nuxoll, San Jose, CA (US)

(73) Assignee: Tesla Motors, Inc., Palo Alto, CA (US)

(21) Appl. No.: 13/671,660

(22) Filed: Nov. 8, 2012

Related U.S. Application Data
(60) Provisional application No. 61/706,915, filed on Sep. 28, 2012.

(51) Int. Cl. G06F 3/01

(52) U.S. Cl. CPC G06F 3/017
USPC 715/727

(57) ABSTRACT

A vehicle audio system interface is provided, as well as a method of using same, in which a visual representation of the vehicle's passenger cabin is displayed on the vehicle's touch-screen. Also displayed on the touch-screen is a touch sensitive balance slide controller and a touch sensitive fade slide controller. As the user makes left-right balance selections on the balance controller, and front-rear fader selections on the fade controller, an acoustic sweet spot designator is presented on the displayed representation of the passenger cabin. The acoustic sweet spot designator, which corresponds to the pre-determined acoustic sweet spot, is based on the combination of the current left-right balance and front-rear fader settings.

### CROSS-REFERENCE TO RELATED APPLICATION

This application claims the benefit of the filing date of U.S. Provisional Patent Application Ser. No. 61/706,915, filed 28 Sep. 2012, the disclosure of which is incorporated herein by reference for any and all purposes.

### FIELD OF THE INVENTION

The present invention relates generally to a user interface and, more particularly, to a vehicle user interface that provides enhanced control of the perceived sound quality of the vehicle's audio system.

### BACKGROUND OF THE INVENTION

A conventional vehicle provides various interfaces that allow the user, i.e., the driver or passenger, a way of monitoring various vehicle conditions as well as controlling different vehicle functions. Depending upon the complexity of the systems to be monitored and/or controlled, such a user interface may utilize visual, tactile and/or audible feedback, and may be comprised of multiple interfaces, each interface grouping together those controls necessary to monitor and/or operate a specific vehicle subsystem (e.g., HVAC, entertainment/audio, navigation, etc.).

The audio system in a conventional vehicle includes a variety of controls, the number and type depending upon both the features offered in the particular system in question as well as the type of user interface implemented in the vehicle. At a minimum the audio system includes a volume control and a source selector that allows the source as well as a particular track or station to be designated. Common audio sources include AM radio, FM radio, HD Radio™, satellite radio, tape, CD, DVD audio, Bluetooth® coupled sources and USB coupled sources. More sophisticated audio systems also provide means for adjusting both the tonal qualities of the audio system and for balancing the output from the various speakers integrated throughout the passenger cabin. In a simple audio system the tonal qualities are adjusted in two frequency bands, i.e., treble and base. More sophisticated audio systems divide the audio spectrum into 3, 5, 7, 10 or more bands. Speaker balance controls are typically limited to left/right control, commonly referred to as balance control, and front/rear control, commonly referred to as fader control. Attempting to balance speaker output on a per-speaker basis is typically not an option available to the end user as such adjustment is exceedingly difficult without specialized acoustic characterization instruments, especially given that many car audio systems include as many as 15 or more speakers.

While there are countless ways of configuring a vehicle's audio system and its controls, generally the overarching goal of the audio system designer is to provide the end user with the best possible audio experience for a given price point and for a given level of audio system sophistication. A secondary, albeit extremely important goal, is to provide the user with a simple means of controlling the audio system, thereby enhancing user enjoyment and simultaneously minimizing the risks associated with controlling a relatively complex system while driving. The present audio system interface achieves both of these goals.

### SUMMARY OF THE INVENTION

A vehicle audio system interface is provided that utilizes a touch-screen mounted within a vehicle, where the touch-screen is configured to display at least one audio system graphical user interface (GUI) control screen that includes a visual representation of the vehicle's passenger compartment. The visual representation, which may be photorealistic, includes a plurality of seat representations that correspond to the actual vehicle seats. The GUI control screen includes a touch sensitive balance slide controller that is comprised of a plurality of user selectable discrete touch sensitive regions and which may be positioned above or below the visual representation of the passenger cabin. Each of the user selectable discrete touch sensitive regions of the balance slide controller, which may be selected using a tapping or tap-and-drag motion, corresponds to one of a plurality of left-right speaker balance settings. The currently selected left-right speaker balance setting may be highlighted on the balance slide controller. The GUI control screen also includes a touch sensitive fade slide controller that is comprised of a second plurality of user selectable discrete touch sensitive regions and which may be positioned to one side of the visual representation of the passenger cabin. Each of the user selectable discrete touch sensitive regions of the fade slide controller, which may be selected using a tapping or tap-and-drag motion, corresponds to one of a plurality of front-rear speaker fader settings. The currently selected front-rear speaker fader setting may be highlighted on the fade slide controller. The system also includes a system controller coupled to the touch-screen and the audio system, the system controller displaying an acoustic sweet spot designator on the visual representation of the vehicle passenger compartment, where the acoustic sweet spot designator is located at an acoustic sweet spot within the vehicle passenger compartment, and where the acoustic sweet spot is pre-determined by a combination of the currently selected left-right balance and front-rear fader settings. The system controller adjusts the location of the acoustic sweet spot designator in response to an adjustment of either the currently selected left-right balance setting or front-rear fader setting.

The acoustic sweet spot within the vehicle passenger compartment is one of a plurality of acoustic sweet spots, with each sweet spot being pre-determined, for example based on an acoustic pre-characterization of the vehicle passenger compartment, and corresponding to a specific combination of left-right balance and front-rear fader settings. Each acoustic sweet spot and its corresponding left-right balance and front-rear fader setting is stored in memory, the memory being coupled to the system controller.

In another aspect of the invention, a method of communicating audio balance information to the end user of a vehicle's audio system is provided, the method including the steps of: (i) providing a touch-screen within the passenger compartment of the vehicle; (ii) displaying an audio system graphical user interface (GUI) control screen on the touch-screen; (iii) displaying a visual representation, which may be photorealistic, of the passenger compartment on the GUI control screen, where the visual representation includes a plurality of seat representations that correspond to the actual vehicle seats; (iv) displaying a touch sensitive balance slide controller on a portion of the GUI control screen (e.g., above/below the visual representation of the passenger compartment), where the balance slide controller is comprised of a plurality of user selectable discrete touch sensitive regions that correspond to one of a plurality of left-right speaker balance settings; (v) displaying a touch sensitive fade slide controller on a second portion of the GUI control screen (e.g., to the side of the visual representation of the passenger compartment), where the fade slide controller is comprised of a second plurality of user selectable discrete touch sensitive regions that correspond to one of a plurality of front-rear speaker fader settings; (vi) accepting left-right speaker balance selections (e.g., via touch or touch-and-drag) via the plurality of user selectable discrete touch sensitive regions of the touch sensitive balance slide controller; (vii) accepting front-rear speaker fader selections (e.g., via touch or touch-and-drag) via the second plurality of user selectable discrete touch sensitive regions of the touch sensitive fade slide controller; (viii) determining the acoustic sweet spot within the passenger compartment that corresponds to the left-right speaker balance selection and the front-rear speaker fader selection, where the acoustic sweet spot is pre-determined and based on a set of acoustic pre-characterization data for the passenger compartment; and (ix) displaying an acoustic sweet spot designator on the visual representation of the passenger compartment, where the acoustic sweet spot designator is located at a position on the visual representation that corresponds to the acoustic sweet spot. The steps of determining the acoustic sweet spot and displaying the acoustic sweet spot designator may be repeated each time a left-right speaker balance selection is accepted and each time a front-rear speaker balance selection is accepted. The set of acoustic pre-characterization data may be comprised of a plurality of acoustic sweet spots, with each of the sweet spots corresponding to a specific combination of a left-right speaker balance selection and a front-rear speaker fader selection. The method may include the step of highlighting the left-right speaker balance selection on the balance slide controller and the step of highlighting the front-rear speaker fader selection on the fade slide controller.

A further understanding of the nature and advantages of the present invention may be realized by reference to the remaining portions of the specification and the drawings.

### BRIEF DESCRIPTION OF THE DRAWINGS

FIG. 1 provides a block diagram of an exemplary interface system that may be used with the present invention;

FIG. 2 provides a depiction of a vehicle's passenger cabin viewed from the top down, this figure including fade and balance slider controls;

FIG. 3 illustrates the same GUI control screen as shown in FIG. 2 after the user has made a minor adjustment of the balance slider, resulting in a minor change in the location of the acoustic sweet spot;

FIG. 4 illustrates a different method of selecting fade and balance control settings;

FIG. 5 illustrates a modified GUI control screen that may be used to select fade and balance control settings;

FIG. 6 illustrates an exemplary set of pre-defined sweet spots located throughout the passenger cabin;

FIG. 7 illustrates operation of the GUI control screen in which pre-defined sweet spots are used to simplify user fade/balance selections;

FIG. 8 illustrates a modified GUI control screen that may be used with the pre-defined sweet spots;

FIG. 9 illustrates the methodology used when the control system includes both pre-defined sweet spots and seat sensors; and

FIG. 10 illustrates the methodology used when the control system include pre-defined sweet spots, seat sensors, and the ability for the user to pre-configure the sweet spot selections.

### DESCRIPTION OF THE SPECIFIC EMBODIMENTS

The preferred embodiment of the present invention utilizes a large format touch-screen, both as a visual aid and as a means of controlling multiple vehicle subsystems, including the audio system. In at least one embodiment, the touch-screen is a 17-inch screen with a 16:10 aspect ratio. Due to its size as well as the limitations on available mounting space in a typical vehicle, preferably this touch-screen is mounted in portrait mode within the vehicle's central console. Besides being aesthetically pleasing, such a mounting location provides access to the data on the screen as well as the displayed system controls to both the driver and the passenger seated in the passenger front seat.

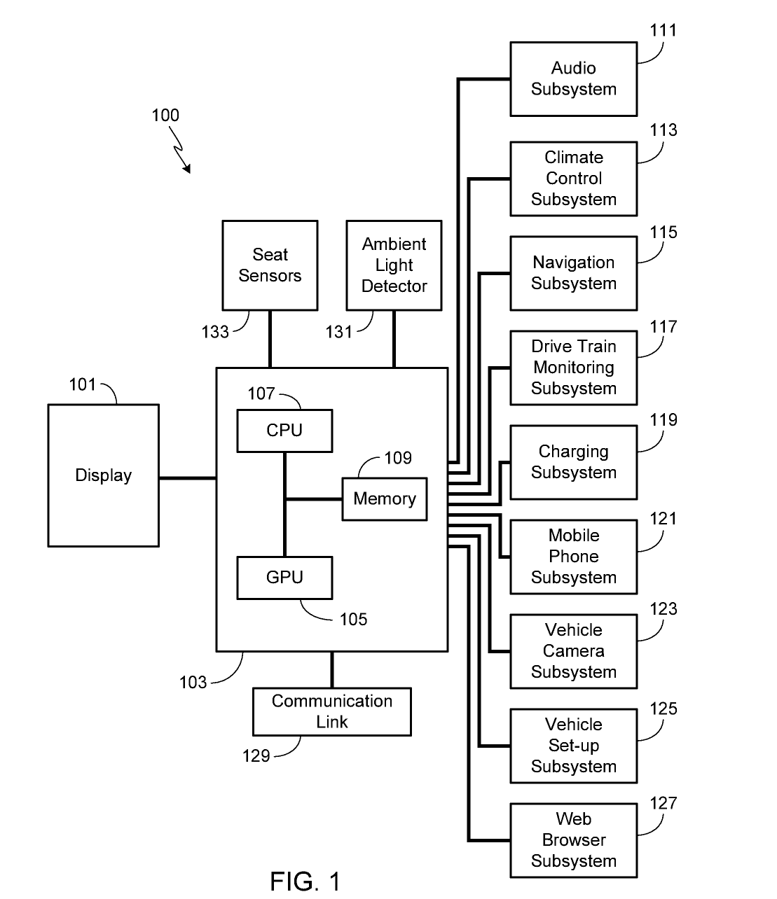

FIG. 1 provides a block diagram of an exemplary interface system 100 that includes touch-screen 101 and is suitable for use with the invention. In system 100, display 101 is coupled to a system controller 103. Controller 103 includes a graphical processing unit (GPU) 105, a central processing unit (CPU) 107, and memory 109. CPU 107 and GPU 105 may be separate or contained on a single chip set. Memory 109 may be comprised of flash memory, a solid state disk drive, a hard disk drive, or any other memory type or combination of memory types. Controller 103 is coupled to a variety of different vehicle subsystems, including the vehicle subsystem controls and vehicle subsystem monitors that are to be accessed and/or viewed on display 101. In addition to audio subsystem 111, preferably controller 103 is also coupled to other vehicle subsystems, for example climate control subsystem 113, navigation subsystem 115, drive train subsystem 117, charging subsystem 119, mobile phone subsystem 121, vehicle camera subsystem 123, vehicle set-up subsystem 125 and web browser subsystem 127. Vehicle set-up subsystem 125 allows general vehicle operating conditions to be set, conditions such as seat position, moon roof or sun roof position/operation, internal and external lighting, windshield wiper operation, etc. Preferably a mobile telecommunications link 129 is also coupled to controller 103, thereby allowing the controller to obtain updates, interface configuration profiles, and other data from an external data source (e.g., manufacturer, dealer, service center, web-based application, remote home-based system, etc.). Mobile telecommunications link 129 may be based on any of a variety of different standards including, but not limited to, GSM EDGE, UMTS, CDMA2000, DECT, and WiMAX.

In a preferred embodiment, interface system 100 allows the user to configure the audio system interface presented on touch-screen 101 in a variety of ways. Typically the user configures the display and controls using the display itself during the configuration process. Alternately, in at least one embodiment the user is able to configure the audio interface using a remote system, for example using a web-based interface application on a home computer, smart phone, tablet or other device, then downloading the configuration instructions to interface controller 103 via communication link 129.

When a particular user configures system 100, thereby personalizing a particular subsystem such as the audio interface to their particular preferences, preferably this set of configuration instructions is retained in memory 109. In a preferred implementation of the invention, system 100 is configured to accommodate multiple drivers/users, allowing each driver/user to record their preferences in memory 109. Preferably system 100 is configured to allow between two and four such configurations to be recorded in memory 109 thus, for example, allowing each driver in a family of four to record their own interface preferences. Then when one of the drivers with a pre-recorded set of interface preferences enters the vehicle, they simply select their previously recorded preferences. Selection of a pre-recorded set of interface preferences may be automatic, for example by utilizing means that identifies a particular driver. Various means that allow the identity of a user to be determined are known, including key fobs with embedded user identification information as well as more sophisticated image recognition systems. Alternately, system 100 may require that a particular user select their previously configured interface preferences, for example by pressing a hard button mounted within the vehicle, or pressing a soft button located on display 101.

In another aspect of the preferred embodiment of the invention, the light intensity or brightness of touch-screen 101 is configured to vary depending upon the ambient light intensity. It will be appreciated that the way in which the brightness varies depends upon the type of display technology employed (e.g., LED, OLED, AMOLED, LCD, etc.) and that the present invention is not limited to a specific type of display technology. The touch-screen light output may have only two levels, i.e., a daylight mode and a nighttime mode, or may vary over multiple steps, thus more accurately accounting for ambient light conditions (e.g., cloudy day versus sunny day). To determine ambient light conditions, controller 103 is preferably connected to an ambient light detector 131. Detector 131 may be mounted within the passenger compartment, for example on the dashboard, or mounted on an exterior location.

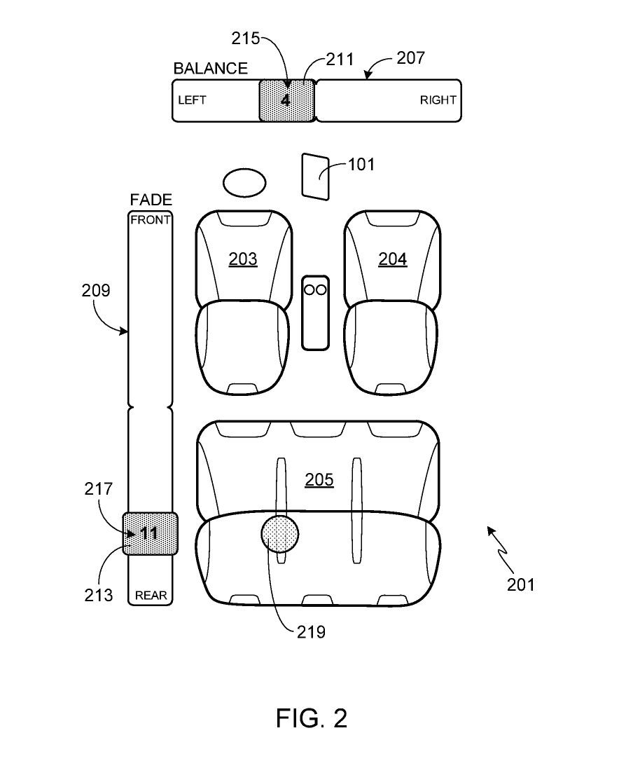

In accordance with the invention at least some, and preferably all, of the controls required to operate audio system 111 are accessed via touch-screen 101. Audio subsystem controls that are regularly required to utilize the audio system during normal operation of the vehicle, such as volume control and source/channel/track selection, are preferably accessed via touch-screen 101, although hard controls (e.g., buttons, rotating selector/level knobs, etc.) may be used for these controls. Those audio system controls that are required to optimize and personalize the sound qualities of the audio system, specifically the fade and balance controls, are accessed via touch-screen 101. The various audio system controls may be provided on a single menu screen displayed on touch-screen 101 or, as preferred, multiple menu screens may be used. In at least one such control screen, or a portion of one such control screen, a visual representation of the interior passenger compartment is provided that includes the balance and fade controls. This aspect of the invention is illustrated in FIGS. 2-8.

The top-down visual representation of passenger compartment 201 in FIGS. 2-8 is an accurate depiction of the passenger compartment in terms of the number of seats as well as the relative sizes and locations of these seats. Preferably the representation of the interior passenger compartment is photorealistic, i.e., a graphical representation that appears to be photographic. Providing the user with an accurate depiction of the passenger compartment helps the user to quickly and correctly identify the desired fade and balance settings. Note that while in the representation shown in FIGS. 2-8 there are two front seats 203/204 and a rear bench seat 205, the invention is clearly applicable to other passenger compartment configurations, e.g., 2 seats, 2+2 seating, three row configurations, etc.

In the fade/balance graphical user interface (GUI) control screen shown in FIG. 2, two slider controls are shown. The upper slider control 207 is used to adjust the left-right balance while vertical slider control 209 is used to adjust the front-rear balance of the audio system. The user adjusts balance controller 207 by touching soft button 211 and sliding it to the left or right (i.e., utilizing a touch-and-drag motion), thereby altering the output of the vehicle's speakers in order to achieve the desired sound distribution. Similarly the user adjusts fade controller 209 by touching soft button 213 and sliding it upwards or downwards (i.e., utilizing a touch-and-drag motion), thereby altering the front/rear speaker output distribution. In at least one configuration, the user may also tap a control bar (e.g., balance control bar 207 and/or fade control bar 209) at the desired location on the control bar, causing the soft button (e.g., soft buttons 211/213) to immediately move to that location. Preferably each soft button includes a numerical label that provides an indication of the relative location of that soft button on the slider control bar, e.g., soft button 211 includes a numerical label 215 (“4” in FIG. 2) and soft button 213 includes a numerical label 217 (“11” in FIG. 2). Note that as used herein, a soft button refers to a pre-defined, touch-sensitive region of touch-screen 101 that activates or otherwise controls a function in a manner similar to that of a hard button (i.e., a toggle switch, a push button, slider control, etc.). As soft buttons are well known in the art, further description will not be provided herein.

In order to obtain the benefits of the present invention, the acoustic properties of the passenger cabin of the vehicle utilizing the invention's fade and balance control system must be tested, analyzed and characterized. Note that since the shape of the passenger cabin, the location of the vehicle seats, and the materials used for the seats, flooring and door panels all affect the acoustic properties of the passenger cabin, preferably the acoustic characterization employed by a particular vehicle's audio system is based on the same model vehicle, as well as a passenger cabin utilizing the same configuration and materials.

During acoustic characterization the acoustic sweet spot, also referred to herein as simply the sweet spot, for each combination of the fade and balance controls is determined, the sweet spot being defined as the location within the cabin that, for a given setting of the fade/balance controls, offers the best balance of sound qualities, i.e., the optimum listening experience. While there is clearly an element of personal taste in determining the sweet spot, there are a variety of techniques and algorithms that may be used to determine the sweet spot based on a recognized set of sound qualities that most people find pleasing.

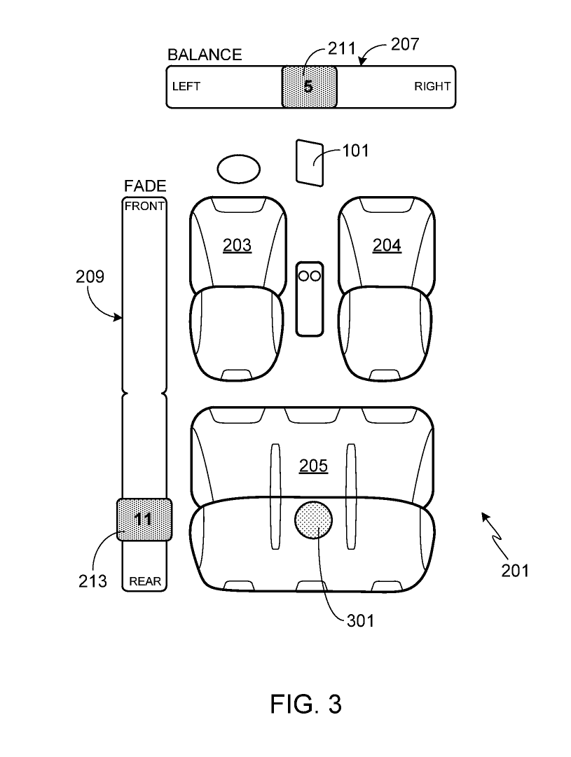

In accordance with one embodiment of the invention, as the user adjusts slider soft buttons 211 and 213, the sweet spot resulting from the user's selection is shown on the GUI control screen. Thus for example, for the fade and balance control settings shown in FIG. 2, system controller 103 identifies the calculated sweet spot and locates a sweet spot designator 219 at this location, the calculated sweet spot being based on the acoustic characterization data taken for that particular passenger cabin configuration which was previously stored in memory 109. In this embodiment the calculated sweet spot is shown on the GUI fade/balance control screen by a sweet spot symbol, i.e., sweet spot designator 219 in FIG. 2. As the user continues to make fade/balance adjustments, the sweet spot and its symbol are also adjusted in real time, thus giving the user immediate visual feedback regarding their selections. FIG. 3 shows the same GUI control screen after the user has made a minor adjustment of the balance control, moving slider soft button 211 to the right. As a result, the sweet spot has been repositioned to the right as shown (see sweet spot designator 301 in FIG. 3).

In the embodiment described above, as the user alters the balance and fade control settings using slider controls 207 and 209, respectively, the system calculates the corresponding acoustic sweet spot and places a sweet spot designator 219 on the touch-screen at the calculated sweet spot for these settings. In a minor modification of this embodiment, the user remotely configures the audio system, including the balance and fade settings, for example using a computer (e.g., home computer), smart phone application, or other remote device. These audio system configuration instructions are communicated to system controller 103 via communication link 129. Once these configuration instructions are received by system controller 103, the system calculates the corresponding sweet spot and appropriately locates the sweet spot designator on touch-screen 101, thus allowing the user to see the results of the fade/balance settings once seated in the vehicle.

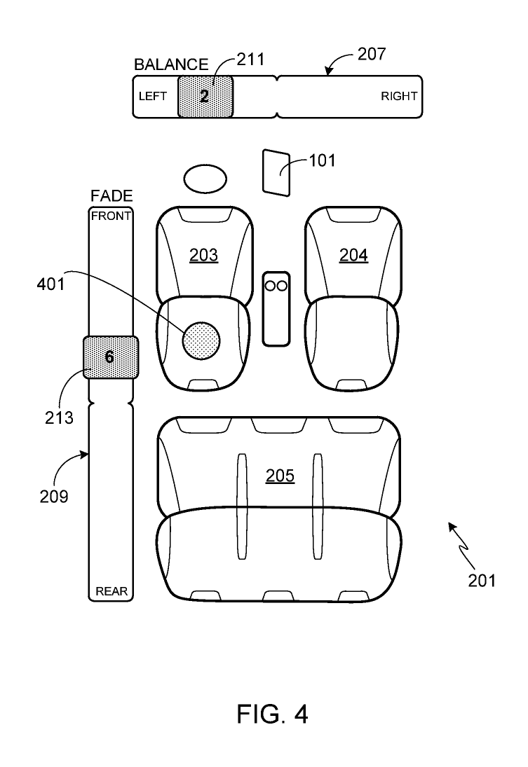

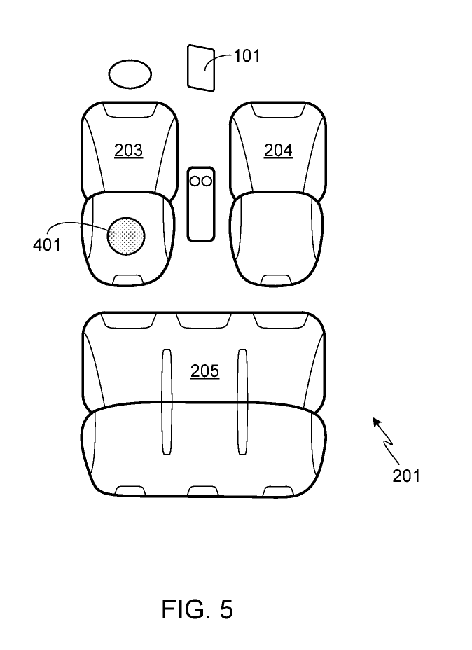

In another embodiment of the invention, the user is able to select fade and balance settings by selecting the desired sweet spot location on the depiction of the passenger cabin. In this embodiment when the user touches a location on the cabin depiction, system controller 103 automatically adjusts the fade and balance controls to achieve the desired sweet spot, the fade and balance settings based on the acoustic characterization data taken for that particular passenger cabin configuration and which was previously stored in memory 109. Thus, for example, when the user touches the GUI fade/balance control screen at a location 401 as shown in FIG. 4, the system automatically adjusts slider soft buttons 211 and 213 as shown. In a minor modification, the user may configure the audio system to only accept fade/balance settings by selecting the sweet spot. Preferably in this modified embodiment fade and balance slider controls 209 and 207 are eliminated from the GUI control screen. Accordingly in this embodiment when the user selects sweet spot 401, system controller 103 simply adjusts the fade and balance controls without indicating the adjustments on the GUI as illustrated in FIG. 5.

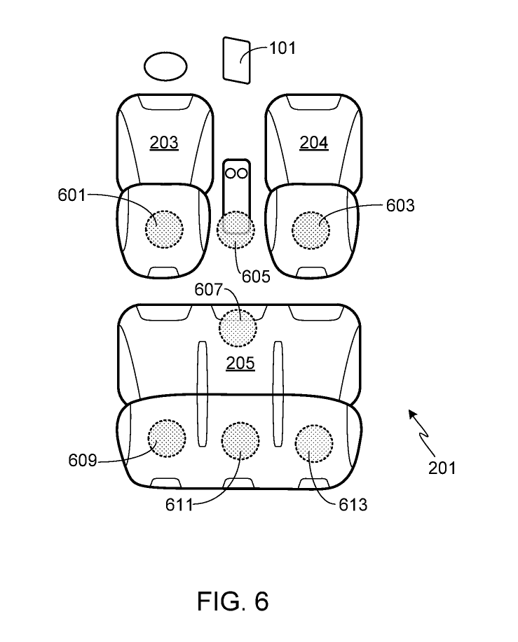

In another embodiment of the invention, the audio system is pre-configured with a preset number of sweet spots, the sweet spots based on the acoustic characterization data taken for that particular passenger cabin configuration and stored in memory. In this embodiment the preset sweet spots are placed at those locations that are commonly selected by users. The preset sweet spots may be displayed or not. FIG. 6 illustrates the GUI fade/balance control screen shown in FIG. 5 with an exemplary set of preset sweet spots shown in phantom. Sweet spot 601 corresponds to fade and balance settings optimized for the driver; sweet spot 603 corresponds to fade and balance settings optimized for the front seat passenger; sweet spot 605 corresponds to fade and balance settings that locates the sweet spot between the driver and the front seat passenger; sweet spot 607 corresponds to fade and balance settings that centrally locates the sweet spot in the passenger cabin, thus providing the best sound quality possible for all vehicle occupants; sweet spot 609 corresponds to fade and balance settings optimized for the left rear passenger; sweet spot 611 corresponds to fade and balance settings optimized for the center rear passenger; and sweet spot 613 corresponds to fade and balance settings optimized for the right rear passenger. It will be appreciated that the system may be configured with either a fewer number or a greater number of preset sweet spots. For example, a simplified configuration may only include three predefined sweet spots; one for the driver (i.e., sweet spot 601), one for the front portion of the cabin (i.e., sweet spot 605), and one for the entire cabin (i.e., sweet spot 607).

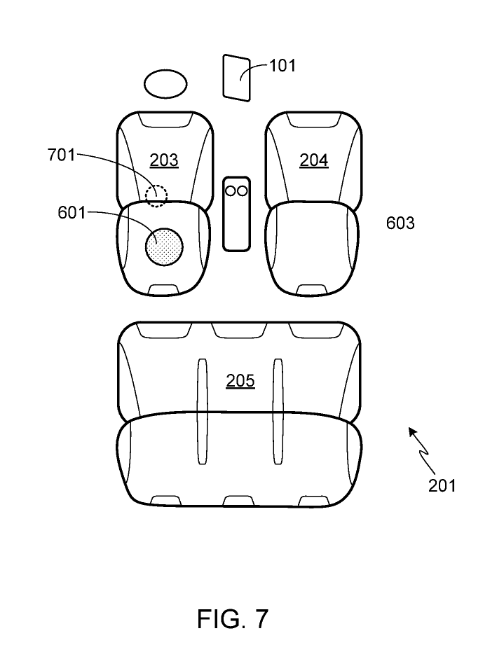

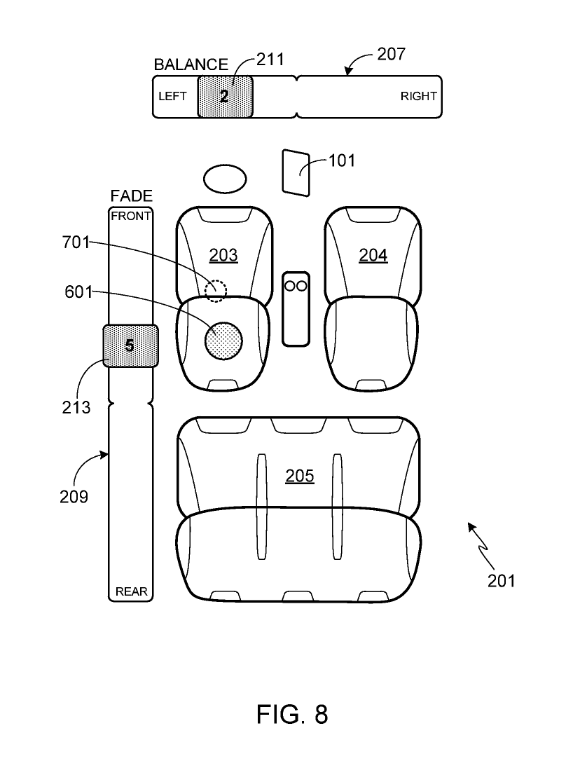

In one embodiment that utilizes a preset number of sweet spots located at pre-defined positions within the passenger cabin such as those shown in FIG. 6, the fade/balance GUI control screen does not show the preset sweet spots. In this configuration, and in a manner similar to that used with the embodiment illustrated in FIG. 4, the user simply touches the GUI control screen at the desired sweet spot location. However, unlike the embodiment illustrated in FIG. 4, in the current embodiment controller 103 adjusts the fade and balance controls for the closest pre-defined sweet spot, thus helping the user to achieve superior sound using a very simple adjustment process. For example if the user touches the screen at location 701 in FIG. 7, controller 103 sets the fade and balance controls to match the settings for sweet spot 601, i.e., the pre-defined sweet spot that is closest to location 701. Preferably the selected sweet spot is shown on the screen as in FIG. 7, although in a minor modification of this embodiment the selected sweet spot is not shown. It should be understood that fade slider control 209 and balance slider controller 207 may be shown with this embodiment, as illustrated in FIG. 8, thus providing the user with an additional means of optimizing the sound quality or making minor adjustments of the fade and balance settings once a sweet spot is selected as described above.

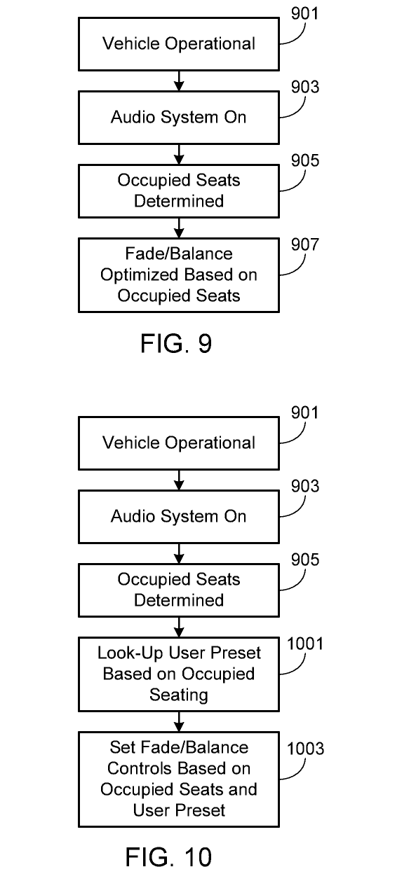

In another embodiment of the invention, seat sensors 133 (e.g., pressure sensors) are located in each of the vehicle's car seats. Each seat sensor 133 is coupled to system controller 103 and provides controller 103 with an indication as to whether the seat to which a particular sensor is attached is occupied. As illustrated in FIG. 9, whenever the vehicle is operating (step 901) and the audio system is on (step 903), system controller 103 determines which seats are occupied (step 905). Controller 103 then optimizes the fade and balance controls based on which seats are occupied and the acoustic characterization data taken for that particular passenger cabin configuration and stored in memory 109 (step 907). Stored in memory are preset sweet spots for each possible combination of occupied seats. Thus, for example, if only the driver's seat is occupied, system controller 103 can be configured to place the sweet spot at location 601. This embodiment may also include a GUI control screen that allows the user to modify the fade/balance settings as described above, for example selecting pre-set sweet spots via direct interaction with the visual representation of the passenger compartment (e.g., as illustrated in FIG. 7) and/or selecting fade/balance settings using a touch-sensitive slide controller (e.g., controllers 207/209 as illustrated in FIG. 2).

In the present embodiment, when controller 103 configures the fade/balance settings, the controller is relying on seat sensors 133 to determine which of the vehicle's seats are occupied and on the preset sweet spots stored in memory. Additionally, controller 103 uses a set of acoustic optimization configuration instructions stored in memory 109, these configuration instructions assigning the desired preset sweet spot for each combination of occupied seats. Typically the configuration instructions are stored in the system memory by the vehicle's manufacturer, although a third party (e.g., a service technician) may store these configuration instructions and/or alter previously stored configuration instructions. In a minor modification of this embodiment, the user sets these acoustic optimization configuration instructions, thereby defining the location for each sweet spot corresponding to each possible combination of occupied seats. As a result, after the controller determines which seats are occupied (step 905), the user-defined preset sweet spot is determined by the system controller based on a simple look-up table recorded in memory 109 based on the user's audio system configuration (step 1001). Controller 103 then sets the fade and balance controls based on which seats are occupied and the user's preset sweet spots (step 1003). Each user-defined sweet spot may be set by the user using balance and fade controllers 207 and 209, respectively. Alternately, the user may select the sweet spot for each set of occupied seats from a set of system pre-defined sweet spots, such as those shown in FIG. 6. By allowing the user to preset the sweet spot for each possible seating scenario, the user is able to personalize the settings. For example, if all of the seats are occupied, the system may determine that the optimum sweet spot is located at position 607. In contrast, for this same seating scenario the user may prefer to set the sweet spot at position 605, or some location between 605 and 607.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A vehicle audio system interface, comprising:
a vehicle audio system comprised of a plurality of speakers;
a touch-screen mounted within a vehicle passenger compartment of a vehicle, said touch-screen configured to display at least one audio system graphical user interface (GUI) control screen providing control over said vehicle audio system, wherein said audio system GUI control screen displays a visual representation of said vehicle passenger compartment, wherein said visual representation includes a plurality of seat representations with each of said plurality of seat representations corresponding to an actual vehicle seat within said vehicle passenger compartment;
a touch sensitive balance slide controller displayed on a first portion of said audio system GUI control screen, said touch sensitive balance slide controller comprised of a first plurality of user selectable discrete touch sensitive regions, wherein each of said first plurality of user selectable discrete touch sensitive regions corresponds to one of a plurality of left-right speaker balance settings associated with said vehicle audio system and said plurality of speakers;
a touch sensitive fade slide controller displayed on a second portion of said audio system GUI control screen, said touch sensitive fade slide controller comprised of a second plurality of user selectable discrete touch sensitive regions, wherein each of said second plurality of user selectable discrete touch sensitive regions corresponds to one of a plurality of front-rear speaker fader settings associated with said vehicle audio system and said plurality of speakers; and
a system controller coupled to said touch-screen and said vehicle audio system, wherein said system controller displays an acoustic sweet spot designator on said visual representation of said vehicle passenger compartment, wherein said acoustic sweet spot designator is located at an acoustic sweet spot within said vehicle passenger compartment, and wherein said acoustic sweet spot is pre-determined by a combination of a first current selection from said first plurality of user selectable discrete touch sensitive regions corresponding to said plurality of left-right speaker balance settings and a second current selection from said second plurality of user selectable discrete touch sensitive regions corresponding to said plurality of front-rear speaker fader settings.

2. The vehicle audio system interface of claim 1, wherein said system controller simultaneously alters a location of said acoustic sweet spot designator on said visual representation of said vehicle passenger cabin in response to adjustment of either said first or second current selections.

3. The vehicle audio system interface of claim 1, wherein said acoustic sweet spot is one of a plurality of acoustic sweet spots within said vehicle passenger compartment, wherein each acoustic sweet spot of said plurality of acoustic sweet spots is pre-determined and corresponds to a specific combination of one of said first plurality of user selectable discrete touch sensitive regions and one of said second plurality of user selectable discrete touch sensitive regions.

4. The vehicle audio system interface of claim 3, wherein each acoustic sweet spot of said plurality of acoustic sweet spots is based on an acoustic pre-characterization of said vehicle passenger compartment.

5. The vehicle audio system interface of claim 3, wherein each acoustic sweet spot of said plurality of acoustic sweet spots is stored in a memory coupled to said system controller.

6. The vehicle audio system interface of claim 1, wherein said visual representation of said vehicle passenger compartment is photorealistic.

7. The vehicle audio system interface of claim 1, wherein said first portion of said audio system GUI control screen corresponding to said touch sensitive balance slide controller is positioned above or below said visual representation of said vehicle passenger compartment on said audio system GUI control screen.

8. The vehicle audio system interface of claim 1, wherein said second portion of said audio system GUI control screen corresponding to said touch sensitive fade slide controller is positioned to one side of said visual representation of said vehicle passenger compartment on said audio system GUI control screen.

9. The vehicle audio system interface of claim 1, wherein each of said first plurality of user selectable discrete touch sensitive regions corresponding to said plurality of left-right speaker balance settings is selectable by tapping, and wherein each of said second plurality of user selectable discrete touch sensitive regions corresponding to said plurality of front-rear speaker fader settings is selectable by tapping.

10. The vehicle audio system interface of claim 1, wherein each of said first plurality of user selectable discrete touch sensitive regions corresponding to said plurality of left-right speaker balance settings is selectable via a touch-and-drag motion on said touch sensitive balance slide controller, and wherein each of said second plurality of user selectable discrete touch sensitive regions corresponding to said plurality of front-rear speaker fader settings is selectable via a touch-and-drag motion on said touch sensitive fade slide controller.

11. The vehicle audio system interface of claim 1, wherein said first current selection of said first plurality of user selectable discrete touch sensitive regions is highlighted on said touch sensitive balance slide controller, and wherein said second current selection of said second plurality of user selectable discrete touch sensitive regions is highlighted on said touch sensitive fade slide controller.

12. A method of communicating audio balance information to an end user, the method comprising the steps of:
providing a touch-screen within a vehicle passenger compartment of a vehicle;
displaying an audio system graphical user interface (GUI) control screen on said touch-screen, said audio system GUI control screen providing control over an audio system integrated within said vehicle;
displaying a visual representation of said vehicle passenger compartment on said audio system GUI control screen, wherein said visual representation includes a plurality of seat representations with each of said plurality of seat representations corresponding to an actual vehicle seat within said vehicle passenger compartment;
displaying a touch sensitive balance slide controller on a first portion of said audio system GUI control screen, said touch sensitive balance slide controller comprised of a first plurality of user selectable discrete touch sensitive regions, wherein each of said first plurality of user selectable discrete touch sensitive regions corresponds to one of a plurality of left-right speaker balance settings associated with said audio system;
displaying a touch sensitive fade slide controller on a second portion of said audio system GUI control screen, said touch sensitive fade slide controller comprised of a second plurality of user selectable discrete touch sensitive regions, wherein each of said second plurality of user selectable discrete touch sensitive regions corresponds to one of a plurality of front-rear speaker fader settings associated with said audio system;
accepting a left-right speaker balance selection via said first plurality of user selectable discrete touch sensitive regions of said touch sensitive balance slide controller;
accepting a front-rear speaker fader selection via said second plurality of user selectable discrete touch sensitive regions of said touch sensitive fade slide controller;
determining an acoustic sweet spot located within said vehicle passenger compartment corresponding to said left-right speaker balance selection and corresponding to said front-rear speaker fader selection, wherein said acoustic sweet spot is pre-determined and based on a set of acoustic pre-characterization data for said vehicle passenger compartment; and
displaying an acoustic sweet spot designator on said visual representation of said vehicle passenger compartment on said audio system GUI control screen, wherein said acoustic sweet spot designator is located at a position on said visual representation that corresponds to said acoustic sweet spot.

13. The method of claim 12, wherein said steps of determining said acoustic sweet spot and displaying said acoustic sweet spot designator are repeated each time said step of accepting said left-right speaker balance selection is performed and each time said step of accepting said front-rear speaker fader selection is performed.

14. The method of claim 12, wherein said set of acoustic pre-characterization data is comprised of a plurality of acoustic sweet spots within said vehicle passenger compartment, wherein each acoustic sweet spot of said plurality of acoustic sweet spots corresponds to a specific combination of one of said first plurality of user selectable discrete touch sensitive regions and one of said second plurality of user selectable discrete touch sensitive regions.

15. The method of claim 12, wherein said step of displaying said visual representation of said vehicle passenger compartment on said audio system GUI control screen further comprises the step of displaying a photorealistic representation of said vehicle passenger compartment on said audio system GUI control screen.

16. The method of claim 12, wherein said step of displaying said touch sensitive balance slide controller on said first portion of said audio system GUI control screen further comprises the step of displaying said touch sensitive balance slide controller above or below said visual representation of said vehicle passenger compartment on said audio system GUI control screen, and wherein said step of displaying said touch sensitive fade slide controller on said second portion of said audio system GUI control screen further comprises the step of displaying said touch sensitive fade slide controller to one side of said visual representation of said vehicle passenger compartment on said audio system GUI control screen.

17. The method of claim 12, wherein said step of accepting said left-right speaker balance selection via said first plurality of user selectable discrete touch sensitive regions of said touch sensitive balance slide controller further comprises the step of highlighting said left-right speaker balance selection on said touch sensitive balance slide controller displayed on said first portion of said audio system GUI control screen, and wherein said step of accepting said front-rear speaker fader selection via said second plurality of user selectable discrete touch sensitive regions of said touch sensitive fade slide controller further comprises the step of highlighting said front-rear speaker fader selection on said touch sensitive balance fade controller displayed on said second portion of said audio system GUI control screen.

18. The method of claim 12, wherein said step of accepting said left-right speaker balance selection further comprises the step of accepting said left-right speaker selection via a first user touch of one of said first plurality of user selectable discrete touch sensitive regions of said touch sensitive balance slide controller, and wherein said step of accepting said front-rear speaker fader selection further comprises the step of accepting said front-rear speaker fader selection via a second user touch of one of said second plurality of user selectable discrete touch sensitive regions of said touch sensitive fade slide controller, wherein either said first user touch or said second user touch may be accepted first.

19. The method of claim 12, wherein said step of accepting said left-right speaker balance selection further comprises the step of accepting said left-right speaker selection via a first user touch-and-drag motion of one of said first plurality of user selectable discrete touch sensitive regions of said touch sensitive balance slide controller, and wherein said step of accepting said front-rear speaker fader selection further comprises the step of accepting said front-rear speaker fader selection via a second user touch-and-drag motion of one of said second plurality of user selectable discrete touch sensitive regions of said touch sensitive fade slide controller, wherein either said first user touch-and-drag motion or said second user touch-and-drag motion may be accepted first.
